(19) United States
(12) Patent Application Publication
(10) Pub. No.: US 2015/0164736 A1
(43) Pub. Date: Jun. 18, 2015

(54) LUBRICATION APPLICATOR FOR BODY LUMEN

(71) Applicant: Esther Gallant, Newport Beach, CA (US)

(72) Inventor: Esther Gallant, Newport Beach, CA (US)

(21) Appl. No.: 14/108,041

(22) Filed: Dec. 16, 2013

(51) Int. Cl. A61H 19/00

(52) U.S. Cl. CPC A61H 19/00; A61H 2205/087; A61H 2201/14

(57) ABSTRACT

An applicator for insertion and lubrication of a body lumen is disclosed having an elongate, hollow, cylindrical reservoir including a rounded distal end to facilitate insertion, and an aperture centrally disposed at said distal end, or central aperture together with additional apertures arranged along the cylindrical reservoir. The reservoir holds a quantity of lubricant, and a mating cylindrical plunger is provided that is sized to be received in a proximal end of the elongate, hollow cylindrical reservoir and adapted to slide within the reservoir to force said quantity of lubricant through said disposed aperture(s). Using the applicator, a body lumen can be lubricated in situ to mimic the body's own lubrication system.

### BACKGROUND

Sexual intercourse is a rewarding part of a healthy and active adult life. In the case of vaginal intercourse, the female physiology is particularly suited to facilitate the act through various changes that take place in the female reproductive system, including lengthening of the vaginal canal, contraction of the muscles surrounding the vagina, and secretions of several glands at the back of the vagina, secretions (sweating) directly from the interior vaginal wall, and secretion of the Bartholins glands at the entrance of the vagina, which secrete relatively minute amounts of fluid (one or two droplets of fluid when the female is sexually aroused). These minute droplets of fluid for lubrication were once believed to be important for lubricating the vagina, but research from Masters and Johnson demonstrated that vaginal lubrication comes primarily from deep within the vagina. The (Bartholins gland) fluid may slightly moisten the labial opening of the vagina, serving to make contact with this sensitive area more comfortable for the woman. Given the vast array of commercially available lubricants for external application, it is clear that for a variety of reasons, some herein discussed, the naturally secreted minor lubrication from the labial opening, is insufficient in many cases, to provide adequate lubrication, with the vast majority of secretions coming from deep within the vagina. All of these changes take place in a healthy female and promote a pleasurable experience for each participant.

While these changes in a woman's body occur during intercourse, many women complain about insufficient secretions causing vaginal discomfort and irritation during or after intercourse. In addition to the absence of the frequent vulvo-vaginal inflammatory-infectious conditions, and of the dryness and hypotrophy of these organs resulting from the post-menopausal estrogen fall, one of the causes for this vaginal irritation during and after intercourse, is vaginal penetration before women are adequately aroused. Considering that the first reaction of the female genitals to sexual excitement is vaginal lubrication, if a woman is penetrated without being properly aroused and, therefore, without the occurrence of the necessary physiological vaginal lubrication, several symptoms of vulvo-vaginal discomfort may occur. In addition, even when adequately aroused, many women suffer from insufficient lubrication for a variety of reasons, some of which have already been mentioned. Insufficient lubrication may also cause a degree of discomfort and irritation to the male penis.

Transudation is the process resulting in vaginal lubrication. When a female is sexually aroused, blood flows into the area surrounding the walls of the vagina in a process called vasocongestion. The pressure of the increased blood causes a seepage of moisture from the spaces between the cells. This moisture cresses the vaginal lining, first appearing as tiny droplets. Eventually, the fluid builds up in sufficient quantity to moisten the entire inner walls of the vagina. In the excitement phase, blood flow to the vagina increases which, in turn, pushes fluid into the vaginal canal. This lubricating process allows for comfortable penile insertion, and repetitive insertions during intercourse.

Natural cyclic hormonal alterations, stress, and the use of combined or progestin-only hormonal contraceptives, if applicable, affect the amount and the consistency of vaginal lubrication during normal daily activities and during sexual arousal. Many medications that women use to treat other conditions can adversely affect vaginal lubrication. These medications include antihistamines, anticholinergics, antihypertensives, and most psychoactive agents, particularly SSRIs and benzodiazepines. Women of any age have various reasons for augmenting their natural vaginal secretions with lubricants or moisturizers to facilitate comfort before, during, and after sexual activity. Additionally, repetitive penetration during intercourse may cause the drying out of the lubrication prior to the completion of the activity. Many men, as well as women, also prefer additional lubrication during sexual activity to increase both their and their partner's enjoyment of sexuality.

One problem with traditional methods and products for augmenting the body's natural lubrication system is that the lubricant is applied at the entrance to the vaginal (or anal) opening. This is unsatisfactory for several reasons. The female body's natural lubrication system secretes lubricant from deep inside the body lumen, where the act of intercourse spreads the lubricant along the walls of the vagina. If the lubricant is applied either to the penis or the entrance of the vagina, the large majority of the lubricant is sheared, and wiped off by the penetrating motion of the penis, greatly diminishing the lubricant's usefulness. Existing commercial products to augment a woman's natural lubrication system are applied, at or close to the vaginal opening, and cannot reproduce the body's design to lubricate from well within the body lumen. The present invention is intended to overcome this shortcoming.

### SUMMARY OF THE INVENTION

The present invention is a lubrication applicator that is used to treat dryness, or supplement the body's natural lubrication, by coating the internal walls and back of the lumen such as the vagina, with a lubricant. By inserting lubricant within the body lumen and applying the lubricant internally to the walls of the body lumen (vaginal or anal), the process of lubrication replicates the body's own lubrication system and provides a more effective application leading to more enjoyable intercourse, eliminating the primary causes of discomfort and pain.

Additionally, the product may be made available prefilled, with the desired or prescribed medical material, as well as an empty applicator to be filled by the users, with a preferred lubricant of the users choosing.

It should be noted that while the present invention is described herein with respect to the application of lubricant, it is to be understood that the present invention has other uses as well, including specifically delivery of medicinal products, as well as vitamins, nutrients, and other materials that from time to time need to be inserted into a body lumen. Accordingly, the invention is intended to encompass all such applications and uses, and is not to be limited to those described herein.

### BRIEF DESCRIPTION OF THE DRAWINGS

The invention is described below in the detailed description of the preferred embodiments, which reference the following drawings accompanying this application.

FIG. 1 an exploded view, partially in cross-section, of a first embodiment of the present invention;

FIG. 2 is another exploded view, partially in cross-section, of the embodiment of FIG. 1;

FIG. 3 is a side view, in cross-section, of a second embodiment of the present invention;

FIG. 4A is a first pressurized lubricant storage container;

FIG. 4B is a second pressurized lubricant storage container;

FIG. 4C is a third pressurized lubricant storage container; and

FIG. 5 is a side view, in cross-section, of a third embodiment of the present invention.

### DETAILED DESCRIPTION OF THE PREFERRED EMBODIMENTS

The present invention is an applicator that encloses a lubricant and has a rounded end which can be safely and comfortably inserted into a body lumen. Once inserted into the body lumen, the applicator can dispense the lubricant directly to the walls of the body lumen, thereby applying a thin layer of lubricant that can protect the lining of the body lumen from abrasion, tearing, or undue friction that can lead to discomfort.

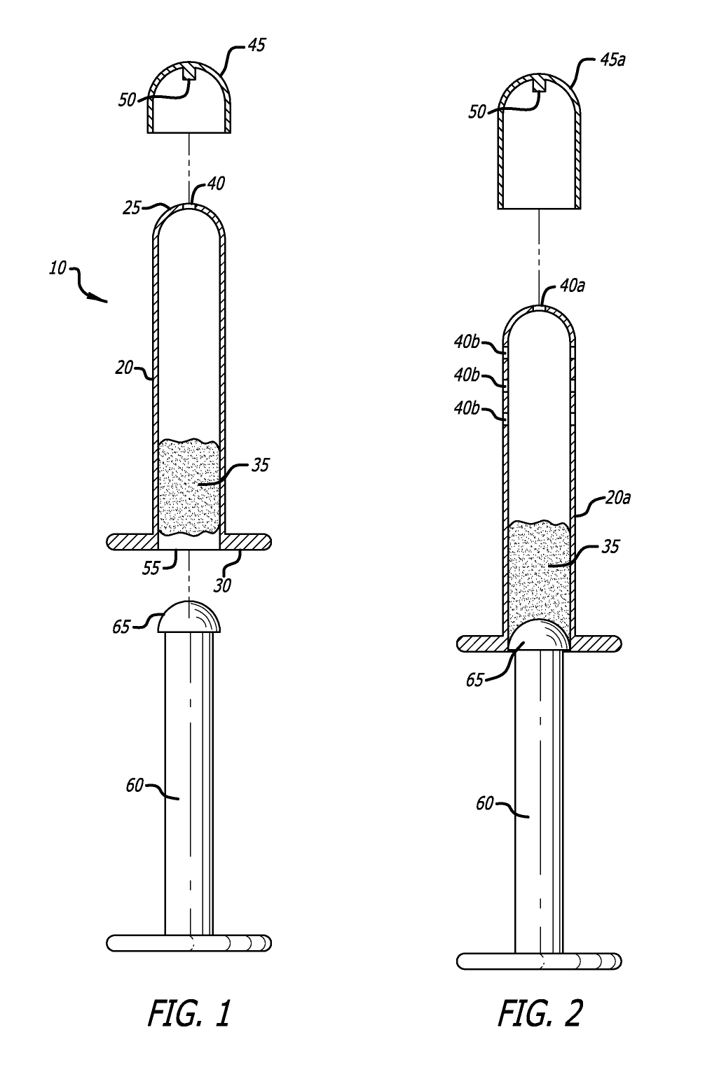

FIG. 1 illustrates a first preferred embodiment of the present invention characterized by an elongate cylindrical syringe that may be filled with a viscous bio-compatible lubricant such as an oil based or water based product currently available in the market. The syringe of the present invention may utilize cartridges, capsules, sponges, or packets to load the lubricant, or it can be poured into the syringe from a larger storage vessel. That is, the syringe may be sold as part of a multi-pack set and a lubricant sold separately that can be used to fill the syringe prior to use. While the syringe would be typically considered single-use and disposable, a refillable syringe could be used to re-lubricant the user during a session. Or a prefilled sealed unit already containing the desired material could be sold for single use. This prefilled unit could also come with a small amount of additional material for use during the single session.

The applicator 10 of FIG. 1 is comprised of a hollow, cylindrical tube 20 having a rounded distal end 25 and an annular rim 30 at a base. The hollow tube 20 may be filled with a lubricant 35, which also may be a medicinal product, biological agent, or other beneficial material. The rounded distal end 25 includes a hole 40 through which the lubricant can egress. The applicator may be fitted with a cap 45 sized to mate with and snugly fit over the rounded, distal end of the cylindrical tube 20. In a preferred embodiment, the cap 45 can include a pin 50 that plugs the hole 40 when the cap 45 is placed over the rounded distal end 25 of the applicator. In this manner, the cylindrical tube 20 can be filled through the open proximal end 55 with a fluid to be delivered to a body lumen. Once the cylindrical tube 20 is loaded with the delivery material 35, a plunger 60 having an annular seal 65 is inserted into the cylindrical tube 20 at the open proximal end 55, and the cap 45 is removed to allow air to escape so that the applicator 10 is primed for delivery of the lubricant 35.

In use, the applicator 20 is inserted into the body lumen. Preferably, prior to insertion a small amount of lubricant is applied to the entrance of the body cavity to facilitate insertion. This can be accomplished by maneuvering the plunger to emit a small amount of lubricant directly to the entrance of the vagina or anus. As the applicator is inserted, the plunger 60 is slowly depressed to eject a small amount of lubricant along the walls of the body lumen as the insertion process progresses. Once the applicator is fully inserted, the remainder of the lubricant 35 is released via the plunger 60, depositing the lubricant at the distal end of the body lumen, emulating the body's own lubrication system. By lubricating the walls and the deepest recess of the body lumen prior to intercourse, the present invention ensures that the lubricant is not sheared away or removed by the act itself, but rather a healthy dose of lubricant is delivered at the site where it is most needed and the thrusting action in combination with the shape of the penis repeatedly drags and spreads the lubricant along the walls of the body lumen. In this manner, intercourse is able to take place in a healthy and well lubricated environment.

FIG. 2 shows an alternate embodiment in which the cylindrical tube 20a is configured with an array of circumferential holes 40b along varying longitudinal lengths of the tube spaced from the distal end 25 in addition to the hole 40a at the rounded distal end. For this embodiment, a cap 45a is elongated to enclose and occlude all of the circumferential holes 40 to prevent leakage through the holes 40b during the loading process. The applicator of FIG. 2 is used in a similar manner to that described above, where fluid is delivered via a mating plunger 60 to the body lumen of choice. The benefit of the applicator of FIG. 2 is that lubricant is delivered peripherally during insertion and evacuation directly to the walls of the body lumen through the holes 40b as well as the hole 40a, increasing the coverage area and dispersing the lubricant more fully to the designated areas. The number and positioning of the holes 40b may be altered to best suit the particular application, and the invention is not limited to any particular number or array of hole pattern.

The present invention is advantageous because it allows lubricant (or medicinal product) to be delivered to the walls of the vagina, anal cavity, or other body lumen where it will not be sheared away by the act itself. The delivery system allows for the consumer to choose the particular lubricant, or in certain cases the applicator may be pre-filled with various types of lubricant of their choice, or if used for medicinal or similar uses, may be prefilled by a pharmacy, a pharmaceutical company, or the like. The shape and size of the applicator is particularly adapted for safe and comfortable insertion and retraction due to the rounded distal end, and width of the applicator that prevents damage to sensitive tissue, and the hollowed tube has smooth straight walls to prevent tearing or puncture. The applicator is designed and intended to be disposable and single use, or used only during a single session, promoting hygienic conditions and safety.

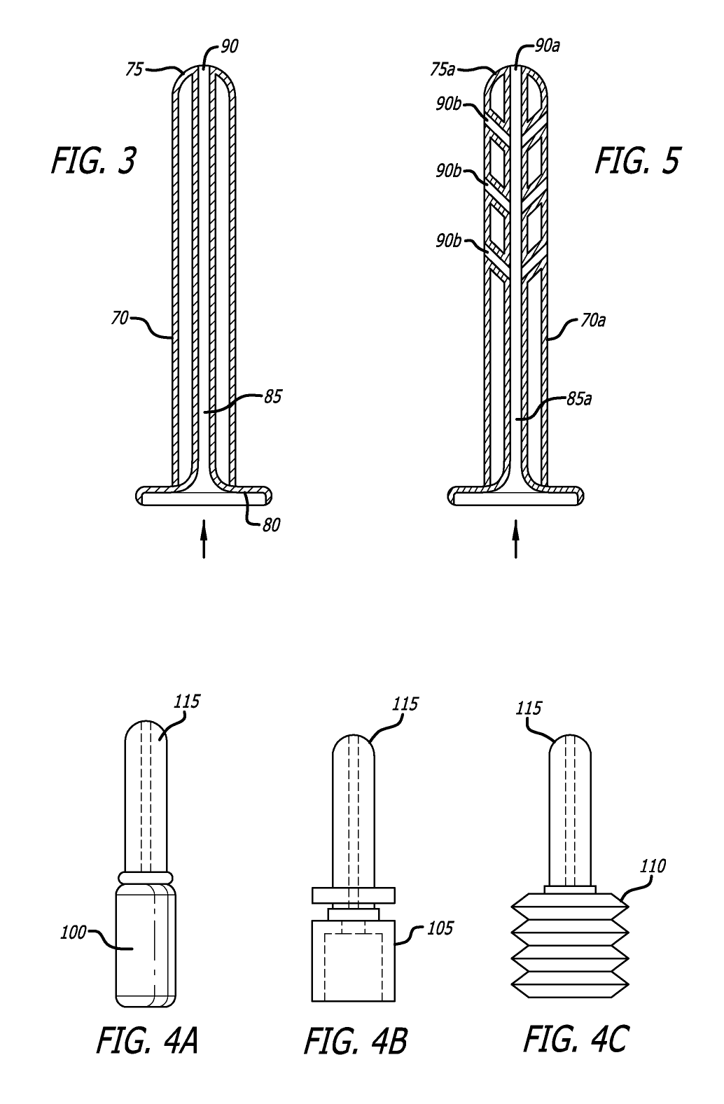

FIG. 3 illustrates yet another preferred embodiment of the present invention, wherein a syringe-type delivery system is replaced with a fluid source requiring pressure and a conduit applicator. The conduit applicator 70 includes the rounded distal end 75 and annular base 80 of the previous embodiments, but includes a central channel 85 that extends from the annular base 80 to the rounded distal end 75. The channel terminates at the distal end at an opening 90, such that lubricant or fluid introduced at the proximal end of the channel flows through the conduit applicator 70 and exits the opening 90 at the distal end of the conduit applicator. FIG. 4a-c illustrates various pressurized liquid sources, including a squeeze bottle 100, a piston and cylinder bottle 105, and a reservoir with a bellows 110 which can all be used to deliver fluid such as lubricant under pressure. Each of these pressurized sources includes a tip 115 that can be used to mate with the central channel 85 at the annular base 80 in a fluid tight and air tight relationship.

To use the embodiment of FIG. 3, the conduit applicator 70 is inserted into the body lumen. This may be accomplished by applying a small amount of lubricant to the outer surface of the conduit applicator 70 and the entrance of the body lumen to facilitate insertion, or by ejecting a small amount of lubricant or other material, as required, from the applicator itself prior to insertion. Prior to inserting into the body lumen, the conduit applicator is mated with a pressurized fluid source such as, for example, the containers shown in FIGS. 4A-C, at the entrance to the central channel 85. Once the applicator is mated to the fluid source, the pressurized fluid is then released into the conduit applicator, where it travels through the central channel 85 until it is dispensed through the distal opening 90 inside the body lumen. The attachment of the pressurized fluid source can be a snap-fit, a threaded mating, a detent-type mating, or any other connection that promotes delivery of the fluid through the central channel 85.

FIG. 5 is an alternative embodiment of FIG. 3, wherein the conduit applicator 70a has a central channel 85a that also branches out peripherally along arteries to openings 90b along the cylindrical wall of the conduit applicator as well as an opening 90a at the tip 75a. Fluid pumped through the central channel 85a will enter the arteries and be dispensed out of the openings 90b as well as the end 90a of the central channel 85a. Thus, as with the embodiment shown in FIG. 2, lubricant can be delivered both at the distal portion of the cavity and along the walls of the cavity, providing a more uniform and thorough film of lubricant to the body lumen.

The embodiments just described and depicted in the accompanying drawings are not intended to be limited, but rather exemplary of the modes and uses of the present invention. It is to be understood that various modifications and alternate uses are envisioned, and the present invention is intended to encompass all such modifications and alternate uses as would be understood by one of ordinary skill in the art.

I claim:

1. An applicator for insertion, delivery of fluid, and lubrication of a body lumen, comprising:
an elongate, hollow, cylindrical reservoir having a rounded distal end including an aperture centrally disposed at said distal end;
a quantity of lubricant disposed in the elongate, hollow, cylindrical reservoir;
a mating cylindrical plunger with rounded distal end sized to be received in a proximal end of the elongate, hollow cylindrical reservoir and adapted to slide within the reservoir to force said quantity of lubricant through said centrally disposed aperture; and
a cylindrical end cap sized to fit over said rounded distal end, said cylindrical cap including a pin adapted to plug said centrally disposed aperture when said cap is mounted on the cylindrical reservoir.

2. The applicator for insertion and lubrication of claim 1, further comprising an array of circumferentially disposed apertures spaced from said distal end of the elongate, hollow reservoir, wherein activation of said mating cylindrical plunger forces lubricant through the circumferentially disposed apertures when the applicator is inserted in the body lumen.

3. A system for delivering lubrication internally to a body lumen comprising:
a source of pressurized lubricant;
a conduit applicator adapted to mate with the source of pressurized lubricant, the conduit applicator including an elongate, cylindrical body having a rounded distal end, and a central channel running a length of the conduit applicator from an attachment of the source of pressurized lubricant to an opening at the rounded distal end;
whereby pressurized fluid enters the applicator conduit at a proximal end and is communicated through the central channel under pressure to the distal end where it exits the distal end through the opening to delivery lubrication to the body lumen from within the body lumen.

4. The system for delivering lubrication internally to a body lumen of claim 3, wherein the central channel of the conduit applicator further comprises arteries that branch from the central channel to a plurality of circumferential openings along a periphery of the conduit applicator;
whereby pressurized fluid enters the applicator conduit at a proximal end and is communicated through the central channel under pressure and through the arteries that brand from the central channel to the circumferential openings and the opening at the rounded distal end to release lubrication at various locations within the body lumen.

5. The system for delivering lubrication internally to a body lumen of claim 3, wherein the source of pressurized lubricant is a squeeze bottle.

6. The system for delivering lubrication internally to a body lumen of claim 3, wherein the source of pressurized lubricant is a bottle with a bellows.

7. The system for delivering lubrication internally to a body lumen of claim 3, wherein the source of pressurized lubricant is a piston and cylinder arrangement.
